(19) United States
(12) Patent Application Publication
(10) Pub. No.: US 2007/0267783 A1
(43) Pub. Date: Nov. 22, 2007

(54) Mold-cooling device

(75) Inventors: Joachim Johannes Niewels, Thornton (CA); Robin Wade Lovell, Oakville (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/436,431

(22) Filed: May 18, 2006

(51) Int. Cl. B29C 49/64

(52) U.S. Cl. 264/327; 425/526; 264/328.14

(57) ABSTRACT

Disclosed, amongst other things, is: (i) a mold-cooling device; (ii) a molding system having a mold-cooling device; (iii) a mold assembly having a mold-cooling device; (iv) a molded article made by a molding system in cooperation with a mold assembly and with a mold-cooling device; and (v) a method of a mold-cooling device.

### TECHNICAL FIELD

The present invention generally relates to, but is not limited to, molding systems (amongst other things), and more specifically the present invention relates to, but is not limited to, (i) a mold-cooling device, (ii) a molding system having a mold-cooling device, (iii) a mold assembly having a mold-cooling device, (iv) a molded article made by a molding system in cooperation with a mold assembly and with a mold-cooling device, and/or (v) a method of a mold-cooling device, amongst other things.

### BACKGROUND

U.S. Pat. No. 4,450,999 (Inventor: Gellert, Jobst U; Published: 1984-05-29) discloses an injection-molding hot-tip seal that resists corrosion because of a protective steel covering but has a highly conductive core.

European Patent Number 0124951A2 (Inventor: van Noort, Jacob; Published: 1984-11-14) discloses injection-molding container-like articles by using a mold split to move a transverse direction of a coke penetration.

U.S. Pat. No. 4,503,483 (Inventor: Basiulis, Algerd; Published: 1985-03-05) discloses an electronic-component heat-pipe cooling module that has an evaporator section provided by wick pads adjacent to flat-outer plates to which circuit components are thermally linked.

U.S. Pat. No. 5,443,381 (Inventor: Gellert, Jobst U.; Published: 1995-08-22) discloses an injection molding gate and a cavity insert for multi-cavity molding that includes rib portions projecting in a cooling-fluid chamber to improve both cooling of plastic melt and structural strength of the cavity insert.

U.S. Pat. No. 5,599,567 (Inventor: Gellert, Jobst U.; Published: 1997-02-04) discloses cooled thread split inserts for injection molding bottle preforms. Steel split inserts are adapted to form the threaded-neck portion of a bottle preform when mounted in a mold, and the inserts have a cooling conduit that extends around a cavity portion.

U.S. Reissued Pat. No. 38,396 (Inventor: Gellert, Jobst Ulrich; Published 2004-01-27) discloses pairs of thread split metal inserts (with internal conduits for a cooling fluid) for injection molding of a ring collar and a thread of a plastic-bottle preform. This patent is a reissue of U.S. Pat. No. 5,930,882.

U.S. Pat. No. 6,079,972 (Inventor: Gellert, Jobst Ulrich; Published: 2000-06-27) discloses an injection molding apparatus that has an elongated cavity in a mold and a cooled mold core made of hollow elongated inner and outer parts with grooves for carrying a cooling fluid.

U.S. Pat. No. 6,488,881 (Inventor: Gellert, Jobst Ulrich; Published: 2002-12-03) discloses an injection-molding apparatus for molding a beverage-bottle preform. The apparatus includes a cooling fluid flow channel extending between an inner and an outer portion of a cavity insert.

United States Patent Application No. 2005/0276879 (Inventor: Niewels, Joachim Johannes et at; Published 2005-12-15) discloses an insert for cooling a neck ring of a molded preform. The insert includes a cooling circuit having an inlet portion for providing a fluid coolant to a divided channel that forms two channels extending in an opposite direction parallel with an inner surface of a neck ring half shell.

United States Patent Application No. 2004/0151937 (Inventor: Hutchinson et al; Published: 2004-08-05) discloses an injection mold assembly, useful for producing preforms for molding into plastic bottles, that includes a wear resistant portion and a high heat transfer portion.

German Patent Number 10024625 (Inventor: Werner et al: Published: 2001-11-22) discloses a mold cooling system, including an annular insert fitted in a groove. The insert made from a material of higher thermal conductivity that the material from which the mold cavity is made.

### SUMMARY

According to a first aspect of the present invention, there is provided a mold system, including a heat-conductive body being substantially mechanical-load decoupled.

According to a second aspect of the present invention, there is provided a molding system, including a mold system, including a heat-conductive body being substantially mechanical-load decoupled.

According to a third aspect of the present invention, there is provided a mold assembly, including a mold system, including a heat-conductive body being substantially mechanical-load decoupled.

According to a fourth aspect of the present invention, there is provided a molded article manufactured by a molding system in cooperation with a mold assembly and a mold system, including a heat-conductive body being substantially mechanical-load decoupled.

According to a fifth aspect of the present invention, there is provided a method, including providing a heat-conductive body having a heat conductivity that is greater than that of a mold assembly.

According to a sixth aspect of the present invention, there is provided a mold system, including a mold assembly linkable to a heat-conductive body, and responsive to application of mechanical load to the mold assembly, the mold assembly substantially prevents mechanical load transmission to the heat-conductive body so that the heat-conductive body remains substantially mechanical-load decoupled.

A technical effect, amongst others, of the aspects of the present invention is permitting a wider range of types of materials that may be selected for a heat-conductive body of a mold cooling device.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is a schematic of a mold-cooling device according to a first exemplary embodiment;

FIG. 2 is a perspective view of the mold-cooling device of FIG. 1;

FIG. 3 is a perspective view of the mold-cooling device according to a second exemplary embodiment (which is the preferred embodiment);

FIG. 4 is another perspective view and a top view of the mold-cooling device of FIG. 3; and

FIG. 5 is a cross section of the mold-cooling device of FIG. 3.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF THE EXEMPLARY EMBODIMENTS

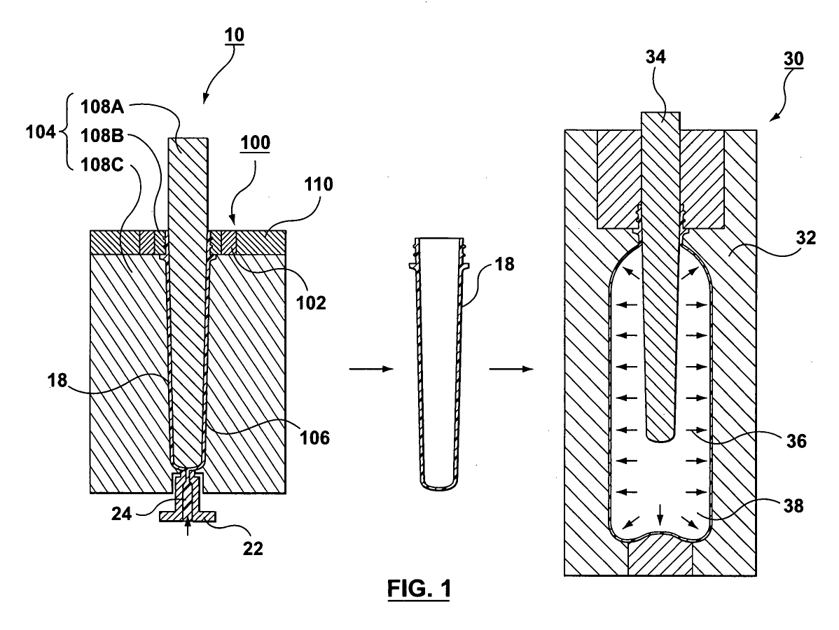

FIG. 1 is a schematic representation of a mold-cooling device 100 (hereafter referred to as “the device 100”) according to the first exemplary embodiment. The device includes a heat-conductive body 102 (hereafter referred to as “the body 102”). The body 102 is cooperative with a mold assembly 104 of a molding system 10 (partially depicted). The molding system 10 is used to manufacture a preform 18 (preferably, to manufacture a plurality of preforms for each cycle of the molding system 10).

Preferably, the body 102 is linkable to the mold assembly 104. Responsive to application of mechanical load (such as a force, a pressure, a strain, etc) to the mold assembly 104, the mold assembly 104 substantially prevents mechanical load transmission to the body 102, and in this manner the body 102 remains substantially mechanical-load decoupled. In addition, responsive to application of mechanical load to the mold assembly 104, the mold assembly 104 endures a substantial amount of applied mechanical load while the heat-conductive body 102 endures an insubstantial amount of the applied mechanical load. Optionally, the heat-conductive body 102 is substantially enclosed by the mold assembly 104. Preferably, the body 102 absorbs as little of the transmitted mechanical load as possible (ideally, none of the mechanical load is absorbed by the body 102).

Preferably, the body 102 has a heat conductivity that is greater than that of the mold assembly 104. The mold assembly 104 defines a molding surface 106, and includes a plurality of mold portions, such as: a core mold 108A, a neck mold 108B (also called a “collar mold”) and a cavity mold 108C. The mold assembly 104 is used to mold the preform 18. Preferably, the body 102 is located proximate to the neck mold 108B, and the neck mold 108B is adapted to form a ring collar and/or a threaded-neck portion of the preform 18. Generally, mold assembly 104 may be used to mold a molded article. The preform 18 is merely an example of a molded article. The neck mold 108B is separable so as to permit removal of the preform 18 from the mold assembly 104 after the preform 18 has been molded. A mold support 110 (sometimes called a base or a mold-support base) is configured to support the mold assembly 104. According to variants, the body 102 is placed or disposed proximate to or adjacent to any of the mold portions of the mold assembly 104.

A technical effect, amongst others, of the body 102 (if the body 102 has a heat conductivity that is greater than that of the mold assembly 104) is that a cycle-time reduction of a molding system that uses a mold-cooling device to manufacture a molded article, such as a preform. By increasing the amount of heat removed from a freshly molded article (that is, increasing cooling thereof), the molded article may then be removed sooner (rather than later) from a mold assembly and thus this arrangement permits a reduction (advantageously) in the cycle time of the molding system.

Generally, the mold assembly 104 is used to mold a molded article. The preform 18 is an example of a molded article. The preform 18 is an object that has been subjected to preliminary, usually incomplete shaping or molding, before undergoing complete or final processing. A molded article is: (i) an object that does not require further molding or shaping (that is, it is a completed object), or (ii) an object that requires further molding or shaping.

The device 100 is installable in a molding system such as the HyPET™ System manufactured by Husky Injection Molding Systems Limited (Location: Bolton, Ontario, Canada; WWW-URL: www.husky.ca). The molding system 10 injects a molding material 24 via a nozzle 22 into a mold cavity defined by the mold assembly 104. Once the molding-system 10 and the mold assembly 104 have cooperatively molded the preform 18, the mold assembly 104 is opened so that a preform-removal device (not depicted) may be used to transfer the preform 18 from the mold assembly 104 of the molding system 10 into a blow mold 32 of a blow molding system 30. After suitable temperature conditioning, an air line 34 is inserted into the cavity of the preform 18 and air pressure 36 is then introduced into the cavity of the preform 18. In response to becoming pressurized, the preform 18 is blown to conform to the blow mold 32, which then forms a completed bottle 38. Then the bottle 38 is removed from the blow mold 32, and the bottle 38 is filled with a beverage (for example).

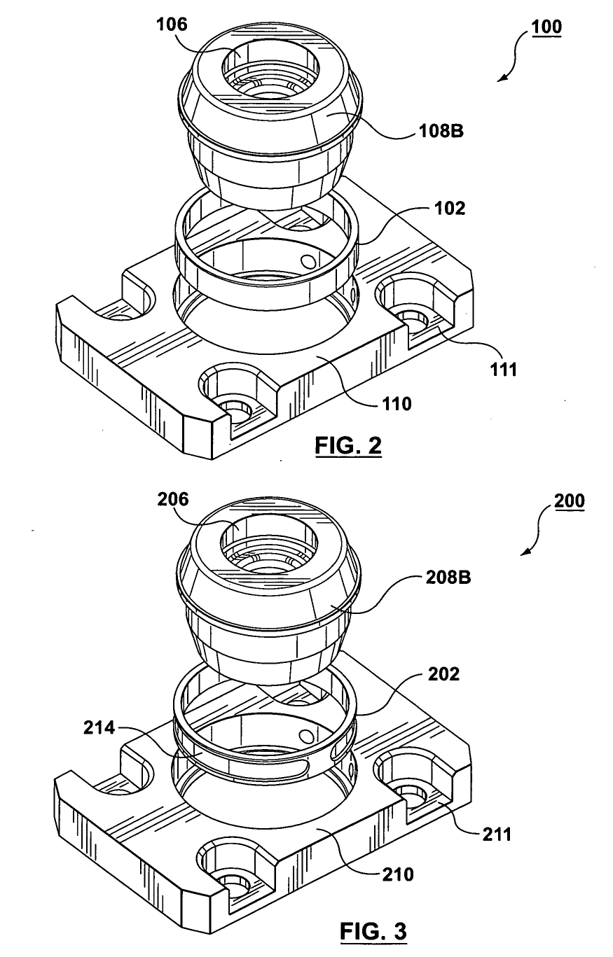

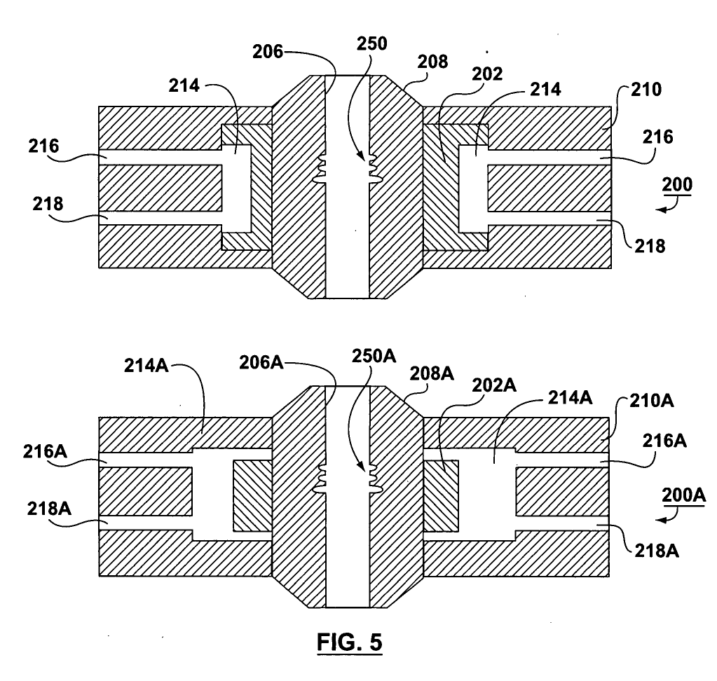

FIG. 2 is a perspective view of the device 100 of FIG. 1. Preferably, the body 102 is contactable against, or is disposed proximate to, the neck mold 108B in such as way that the body 102 is disposed between the mold support 110 and the neck mold 108B so that once assembled, the body 102 contacts the neck mold 108B. The body 102 is shaped so as to surround the neck mold 108B at least in part. The neck mold 108B includes tapered locking surfaces for locking the neck mold 108B into position in the molding system 10. A purpose of the body 102 is to improve cooling of the ring collar and/or the threaded-neck portion of preform 18 (that is molded by the neck mold 108B) once the molding material has been injected into the cavity of the mold assembly 104, so that in this manner the number and/or severity of molding defects may be reduced (as discussed below for FIG. 5). According to alternatives, the body 102 is used to improve cooling of other sections of the preform 18 (that is, sections other than the ring collar and/or the threaded-neck portion). Preferably, the mold support 110 includes a mounting connection 111 so that the mold support 110 may be connected to the structure of the molding system 10.

The body 102 includes a material (such as copper or silver) that is multi-directionally heat conductive. Preferably, the mold support 110 and the mold assembly 104 both include a durable material (such as steel); however, other metals and/or alloys may be used as well.

Once the neck mold 108B, the body 102 and the mold support 110 are assembled, the assembly of parts is braised so as to weld the parts together, and then the assembly of parts is cut in half (as known to those skilled in the art); this arrangement permits the halves of the neck mold 108B to be separated after the preform 18 has been molded so that the preform 18 may be easily removed from the neck mold 108B.

FIG. 3 is a perspective view of the mold-cooling device 200 (hereafter referred to as “the device 200”) according to the second exemplary embodiment. The device 200 includes a heat-conductive body 202 (hereafter referred to as “the body 202”). To facilitate an understanding of the second exemplary embodiment, elements of the second exemplary embodiment (that are similar to those of the first exemplary embodiment) are identified by reference numerals that use a two-hundred designation rather than using a one-hundred designation (as used in the first exemplary embodiment). For example, the body of the second exemplary embodiment is labeled 202 rather than being labeled 102, etc.

A mold support 210 is configured to support a neck mold 208B. A coolant passageway 214 is used to convey a cooling fluid to and away from the body 202. The cooling fluid further improves cooling of the body 202 by assisting in the removal of heat from the preform 18. According to the second exemplary embodiment, the cooling fluid is used in cooperation with the body 202. According to the first exemplary embodiment, a cooling fluid is not used.

Preferably, the coolant passageway 214 is configured in the following manner: the body 202 defines a groove that faces (or is oriented to face) the mold support 210, while the mold support 110 presents an un-grooved surface that faces the body 202. Once the body 202 contacts and seals against the mold support 210, the cooling fluid does not leak from the groove. According to a variant (not depicted), the mold support 210 defines a groove that faces the body 202 while the body 202 presents an un-grooved surface that faces the mold support 210. According to another variant (not depicted), the body 202 defines a coolant passageway therein, and the mold support 210 defines a coolant passageway that connects to the coolant passageway of the body 202. According to another variant (not depicted), the mold support 210 defines a coolant passageway that is aligned proximate to (or adjacent to) the body 202 without touching the body 202.

In an alternative (not depicted), a turbulence-inducing structure extends from the body 202 into the passageway 214, and the deflector is configured to induce cooling-fluid turbulence to further improve the cooling effect of the body 202. In another alternative (not depicted), a deflector extends from the body 202 into the coolant passageway 214. An alternative to the deflector is a recess (not depicted) that may be defined by the body 202 and/or the mold support 210.

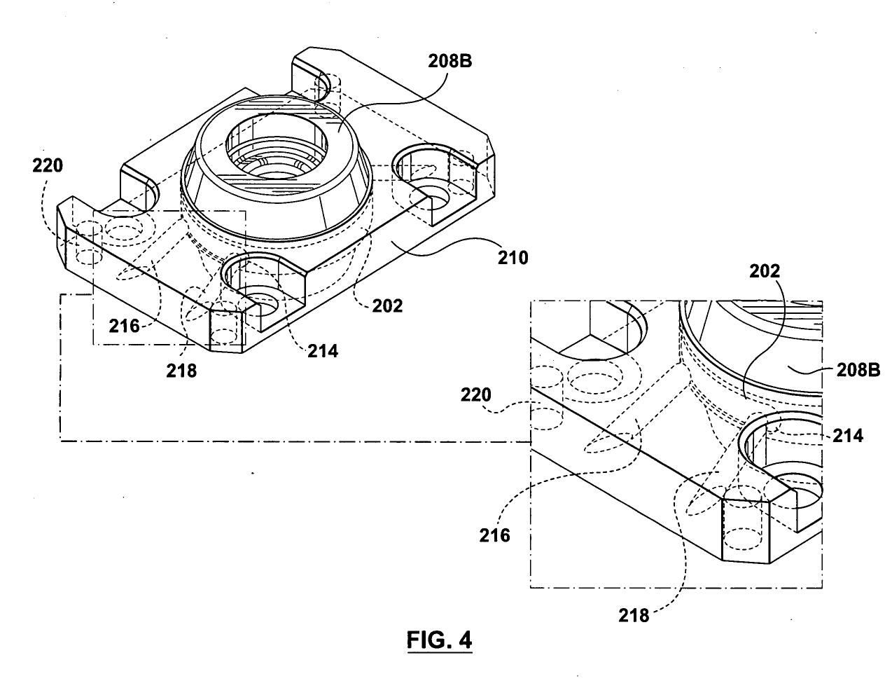

FIG. 4 is a close-up perspective view and a top view of the device 200 of FIG. 3. The mold support 210 includes: (i) a cooling-fluid inlet 212 that leads to a coolant passageway 214 (depicted as a groove) that is cooperative with the body 202, and (ii) a cooling-fluid outlet 218 that leads away from the coolant passageway 214 (depicted as a groove) that is cooperative with the body 202.

The body 102, 202 may be supplied or sold in the following arrangements: (i) the mold-cooling device 100, 200 (respectively), (ii) the molding system 10 that has the mold-cooling device 100, 200 (respectively), (iii) the mold assembly 104, 204 including the mold-cooling device 100, 200 (respectively), (iv) a molded article manufactured by the molding system 10 in cooperation with the mold assembly 104, 204 and the mold-cooling device 100, 200 (respectively), a method of the mold-cooling device 100, 200.

FIG. 5 is a cross section of the mold-cooling device 200 of FIG. 3, along with a cross section of a variant device 200A. The body 202 is positioned to abut the neck mold 208. A cooling fluid will be able to make contact with the body 202. Preferably, the body 202 abuts the top portion and the bottom portion of the mold support 210.

The variant device 200A is similar to that of the device 200, except that the body 202A does not abut the top portion and the bottom portion of the mold support 210A, but rather a gap is permitted therebetween so that thermal expansion of the body 202 may be permitted without having the body 202 experience a mechanical load applied to the mold 204. The body 202 has a propensity to draw heat away from the article being cooled in the mold faster than the rate at which the cooling fluid can draw heat away from the article.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A mold system (100; 200), comprising:
a heat-conductive body (102; 202) being substantially mechanical-load decoupled.

2. The mold-cooling device (100; 200) of claim 1, wherein the heat-conductive body (102; 202) includes a material that:
promotes heat flow away from the mold assembly (104; 204), and
retards heat flow in a direction toward the mold assembly (104; 204).

3. The mold-cooling device (100; 200) of claim 1, wherein the heat-conductive body (102; 202) is linkable to a mold assembly (104; 204), and responsive to application of mechanical load, the mold assembly (104; 204) substantially prevents mechanical load transmission to the heat-conductive body (102; 202), so that the heat-conductive body (102; 202) remains substantially mechanical-load decoupled.

4. The mold-cooling device (100; 200) of claim 1, wherein responsive to the application of mechanical load to the mold assembly (104; 204), the mold assembly (104; 204) endures a substantial amount of applied mechanical load while the heat-conductive body (102; 202) endures an insubstantial amount of the applied mechanical load.

5. The mold-cooling device (100; 200) of claim 1, wherein the heat-conductive body (102; 202) is substantially enclosed by a mold assembly (104; 204).

6. The mold-cooling device (100; 200) of claim 1, wherein a heat-conductive body (102; 202) having a heat conductivity being greater than that of a mold assembly (104; 204).

7. The mold-cooling device (100; 200) of claim 1, wherein the heat-conductive body (102; 202) is contactable against the mold assembly (104; 204).

8. The mold-cooling device (100; 200) of claim 1, wherein the mold assembly (104; 204) defines a molding surface (106; 206), and the heat-conductive body (102; 202) is disposed proximate to the molding surface (106; 206).

9. The mold-cooling device (100; 200) of claim 1, further comprising:
a mold support (110; 210) configured to support the mold assembly (104; 204).

10. The mold-cooling device (100; 200) of claim 1, further comprising:
a mold support (110; 210) configured to support the mold assembly (104; 204), wherein the heat-conductive body (102; 202) is disposed between the mold support (110; 210) and the mold assembly (104; 204).

11. The mold-cooling device (100; 200) of claim 1, wherein the heat-conductive body (102; 202) is curved.

12. The mold-cooling device (100; 200) of claim 1, wherein the heat-conductive body (102; 202) includes a material being heat conductive multi-directionally.

13. The mold-cooling device (200) of claim 1, further comprising:
a mold support (210) configured to support the mold assembly (204), and includes:
a cooling-fluid inlet (212) leading to a coolant passageway (214) that is cooperative with the heat-conductive body (202); and
a cooling-fluid outlet (214) leading away from the coolant passageway (214) that is cooperative with the heat-conductive body (202).

14. The mold-cooling device (200) of claim 1, further comprising:
a mold support (210) configured to support the mold assembly (204); and
a coolant passageway (214) cooperative with the heat-conductive body (202).

15. The mold-cooling device (200) of claim 1, further comprising:
a mold support (210) configured to support the mold assembly (204); and
a coolant passageway (214) cooperative with the heat-conductive body (202), the heat-conductive body (202) defines a groove that faces the mold support (210).

16. The mold-cooling device (200) of claim 1, further comprising:
a mold support (210) configured to support the mold assembly (204); and
a coolant passageway (214) cooperative with the heat-conductive body (202), the mold support (210) defines a groove that faces the heat-conductive body (202).

17. The mold-cooling device (200) of claim 1, wherein the heat-conductive body (202) provides a turbulence-inducing structure configured to induce cooling-fluid turbulence.

18. A molding system (10), comprising:
the mold-cooling device (100; 200) of any one of claims 1 to 17.

19. A mold assembly (104), comprising:
the mold-cooling device (100; 200) of any one of claims 1 to 17.

20. A molded article manufactured by a molding system (10) in cooperation with a mold assembly (104) and the mold-cooling device (100; 200) of any one of claims 1 to 17.

21. A method, comprising:
providing a heat-conductive body (102; 202) having a heat conductivity that is greater than that of a mold assembly (104; 204).

22. The method of claim 21, wherein the heat-conductive body (102; 202):
promotes heat flow away from the mold assembly (104; 204), and
retards heat flow in a direction toward the mold assembly (104; 204).

23. The method of claim 21, further comprising:
contacting the heat-conductive body (102; 202) against the mold assembly (104; 204).

24. The method of claim 21, further comprising:
disposing the heat-conductive body (102; 202) proximate to the molding surface (106; 206).

25. The method of claim 21, further comprising:
disposing the heat-conductive body (102; 202) between a mold support (110; 210) and the mold assembly (104; 204).

26. The method of claim 21, further comprising:
multi-directionally conducting heat from the mold assembly (104; 204).

27. The method of claim 21, further comprising:
placing a coolant passageway (214) cooperative with the heat-conductive body (202).

28. The method of claim 21, further comprising:
inducing turbulence onto a cooling-fluid (112) located in a coolant passageway (214) that is placed cooperative with the heat-conductive body (202).

29. A mold system (100; 200), comprising:
a mold assembly (104; 204) linkable to a heat-conductive body (102; 202), and responsive to application of mechanical load to the mold assembly (104; 204), the mold assembly (104; 204) substantially prevents mechanical load transmission to the heat-conductive body (102; 202) so that the heat-conductive body (102; 202) remains substantially mechanical-load decoupled.
